(19) United States
(12) Patent Application Publication
(10) Pub. No.: US 2005/0066816 A1
(43) Pub. Date: Mar. 31, 2005

(54) Tracheostomy nebulizing pad

(76) Inventor: Vivian A. Wright, Coral Gables, FL (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/674,655

(22) Filed: Sep. 29, 2003

(51) Int. Cl. B01D 53/02

(52) U.S. Cl. 96/108

(57) ABSTRACT

A method and apparatus for nebulizing a tracheostomy tube are disclosed. A nebulizing pad includes a flap and an absorbent central core for containing a nebulizing agent. The absorbent central core is saturated with a nebulizing agent and placed proximate to the opening of a tracheostomy tube by adhering the flap to an edge of the tracheostomy tube. A user nebulizes the tracheostomy tube by inhaling air through the absorbent central core into the tracheostomy tube. As inhaled air passes through the absorbent central core, at least a portion of the nebulizing agent intermixes with the air in vaporous form. This moistened air vapor intermixture then enters the tracheostomy tube and nebulizes the tube and the trachea.

### FIELD OF INVENTION

The present invention relates generally to an apparatus in the field of respiratory therapy, and more particularly to an apparatus for communicating with an opening of a tracheostomy tube and continuously delivering moist air produced by inhalation of water vapor through an absorbent nebulizing pad to the trachea of a user.

### BACKGROUND OF THE INVENTION

Tracheostomy tubes are used to provide airflow to patients suffering from respiratory problems. In normal operation, air is inhaled and exhaled through a tracheostomy tube by a person fitted with the tube. Air inhaled through a tracheostomy tube may lack moisture because the air does not pass through either the mouth or nasal passages, which supply moisture during normal respiration. Dry inhaled air may compromise the user's tracheal tube. In addition, the trachea may become irritated over time causing damage to the user's trachea or stoma.

Nebulizing devices have been developed to provide moisture to air inhaled through a tracheostomy tube. Some previous nebulizing devices have generally been electrically powered and non-portable. As such, the devices required a user to remain generally immobile during the nebulization process. Other devices have required a user to tie a string, ribbon or strap around his neck to position the nebulizing device in front of the tracheostomy tube. Such devices may cause discomfort to the user. Moreover, such devices are more likely to be jarred from their desired position by the user's movements.

What is needed is a nebulizing device that allows for the nebulizing of the trachea by way of portable convenience to the user. A further need has been felt for a portable nebulizing device that remains in a position proximate to the opening of a tracheostomy tube during the nebulizing process.

### SUMMARY OF THE INVENTION

The present invention is directed to solving one or more of the aforementioned needs or problems.

In a preferred embodiment of the present invention, a nebulizing pad includes a flap and an absorbent central core attached to the flap. The flap includes an adhesive coating that may be pressure-sensitive. The adhesive coating includes one or more adhesive strips. In an embodiment, the flap is shaped as an arched rectangle. The flap may also be made of a flexible material. In an embodiment, the absorbent central core is formed from a material selected from the group consisting of fabrics, natural fibers, synthetic fibers and cellulose derivatives. The absorbent central core may include one or more portions that are pervious to liquids.

In a preferred embodiment, a method of nebulizing a tracheostomy tube of a user using a nebulizing pad having a flap and an absorbent central core attached to the flap includes adhering the flap of the nebulizing pad to an edge of the tracheostomy tube so that the absorbent central core of the nebulizing pad is positioned in front of an opening of the tracheostomy tube, placing a nebulizing agent on the absorbent central core, and using the nebulizing agent to nebulize the tracheostomy tube. The flap includes an adhesive coating and, preferably is adhered to the top exterior edge of the tracheostomy tube. In an embodiment, the adhesive coating of the flap is pressure-sensitive and includes one or more adhesive strips. In an embodiment, the nebulizing agent includes water. The absorbent central core may be located proximate to the opening of the tracheostomy tube. In an embodiment, placing the nebulizing agent comprises saturating the absorbent central core with the nebulizing agent. In an embodiment, using the nebulizing agent includes inhaling, by the user, through the tracheostomy tube and, in response to the inhaling, nebulizing the tracheostomy tube with at least a portion of the nebulizing agent.

This apparatus and method provide several advantages, including an increase in patient comfort and an increase in the reliability and lifespan of the tracheostomy tube, as it is less likely to be compromised. In addition, a higher level of medical care may result through the persistent nebulizing of the trachea and stoma. Another advantage of the apparatus is that it may be manufactured from readily available materials, utilizing common manufacturing technologies and techniques.

### BRIEF DESCRIPTION OF THE DRAWINGS

In part, other aspects, features, benefits and advantages of the embodiments of the present invention will be apparent with regard to the following description, appended claims and accompanying drawings where:

FIG. 1 illustrates a front view of an exemplary tracheostomy nebulizing pad according to an embodiment of the present invention.

FIG. 2 illustrates a rear view incorporating the adhesive side of an exemplary tracheostomy nebulizing pad according to an embodiment of the present invention.

FIG. 3 depicts a front view of an exemplary tracheostomy nebulizing pad attached to a tracheostomy tube according to an embodiment of the present invention.

FIG. 4 depicts a side view of an exemplary tracheostomy nebulizing pad with an attached adhesive strip according to an embodiment of the present invention.

FIG. 5 illustrates a side view of an exemplary tracheostomy nebulizing pad attached to a tracheostomy tube inserted in a stoma according to an embodiment of the present invention.

FIG. 6 illustrates a side view of an exemplary tracheostomy nebulizing pad attached to a tracheostomy tube according to an embodiment of the present invention.

FIG. 7 depicts a side view of an exemplary tracheostomy nebulizing pad according to an embodiment of the present invention with airflow cascading between the exemplary tracheostomy nebulizing pad and the tracheostomy breathing passageway.

FIG. 8 depicts a side view of an exemplary tracheostomy nebulizing pad according to an embodiment of the present invention attached to a tracheostomy tube as water vapor from the exemplary tracheostomy nebulizing pad is mixed with inhaled air and taken through the tracheostomy tube passageway to reach and moisturize the orifice.

FIG. 9 depicts a side view of an exemplary tracheostomy nebulizing pad according to an embodiment of the present invention attached to a tracheostomy tube as exhaled air passes unimpeded out through the tracheostomy tube passageway.

FIG. 10 illustrates a side view of an exemplary tracheostomy nebulizing pad according to an embodiment of the present invention attached to a tracheostomy tube as secretions, such as mucus and irradiated tissue, are expelled from the orifice through the passageway opening of the tracheostomy tube.

### DETAILED DESCRIPTION OF THE INVENTION

Before the present compositions and methods are described, it is to be understood that this invention is not limited to particular compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an” and “the” include plural references unless the context clearly dictates otherwise. Thus, for example, reference to a “nebulizing pad” is a reference to one or more nebulizing pads and equivalents thereof known to those skilled in the art, and so forth. Unless defined otherwise, all technical and scientific terms used herein have the same meanings as commonly understood by one of ordinary skill in the art. Although any methods, devices and material similar or equivalent to those described herein can be used in the practice of testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

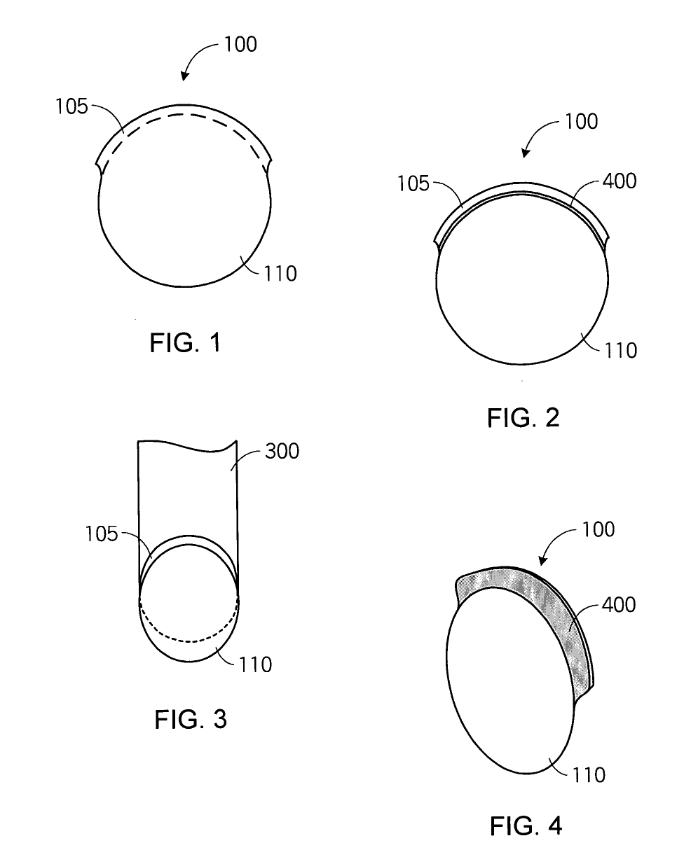

FIG. 1 illustrates a front view of an exemplary tracheostomy nebulizing pad according to an embodiment of the present invention. The tracheostomy nebulizing pad 100 may include a flap 105 and an absorbent central core 110. The absorbent central core 110 maybe formed from a material selected from the group consisting of fabrics, natural fibers, synthetic fibers, cellulose derivatives and combinations thereof. The absorbent central core 110 may include top and bottom sheets that are pervious to liquids.

FIG. 2 illustrates a rear view incorporating the adhesive side of an exemplary tracheostomy nebulizing pad according to an embodiment of the present invention. The flap 105 of the nebulizing pad 100 may include a substrate on one side for contacting an exposed surface of a tracheostomy tube. The substrate may include a pressure sensitive adhesive coating 400 on a contact side for adhering to the surface of the tracheostomy tube, as shown in FIG. 4. The body of the flap 105 may contain a flexible axis about which the flap may fold away from the absorbent central core 110 to form a base of a wall. This wall may extend to the flexible axis in the body of the flap 105, which is folded over a tracheostomy tube 300, as shown in FIG. 3. The absorbent central core 110 of the nebulizing pad 100 may preferably bend at the line of juncture and longitudinal edge of the flap 105. The flap 105 may preferably include a liquid-impervious front and back sheet. Additionally, the flap 105 may have a flexible axis for allowing the flap to be folded at a right angle to the absorbent central core 110. In a preferred embodiment, the flap 105 may be flexible.

FIG. 3 depicts a front view of an exemplary tracheostomy nebulizing pad attached to a tracheostomy tube according to an embodiment of the present invention. In a preferred embodiment, the adhesive substrate of the flap 105 may be attached to the exterior top edge of the tracheostomy tube 300. Proper placement of the flap 105 during adherence to the tracheostomy tube 300 may ensure persistent nebulization of the tracheostomy tube and minimize discomfort for the user.

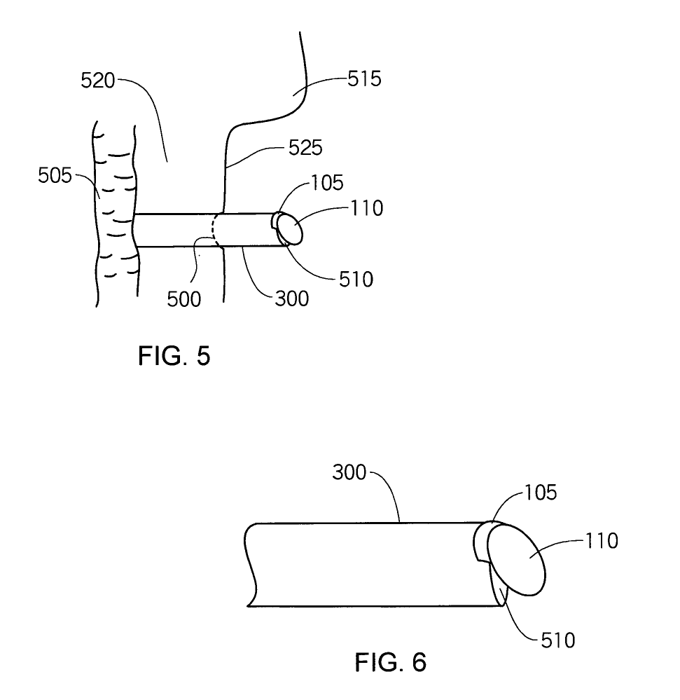

FIG. 5 illustrates a side view of an exemplary tracheostomy nebulizing pad attached to a tracheostomy tube inserted in a stoma according to an embodiment of the present invention. In normal operation, a tracheostomy tube 300 is inserted through a stoma 500 in the neck to contact the trachea 505. The flap 105 may be placed on an edge of the tracheostomy tube 300 such that the absorbent central core 110 is positioned over the passageway opening 510 of the tracheostomy tube. In a preferred embodiment, the flap 105 may be placed over the top exterior edge of the tracheostomy tube 300 such that the absorbent central core 110 drapes over the passageway opening 510. FIG. 6 shows a more detailed view of the absorbent central core 110 draping over the rim of the tracheostomy tube 300 to align with the opening of the tube. In a preferred embodiment, the flap 105 is shaped as an arched rectangle for adhering to a cylindrical tracheostomy tube 300, as shown in FIG. 6.

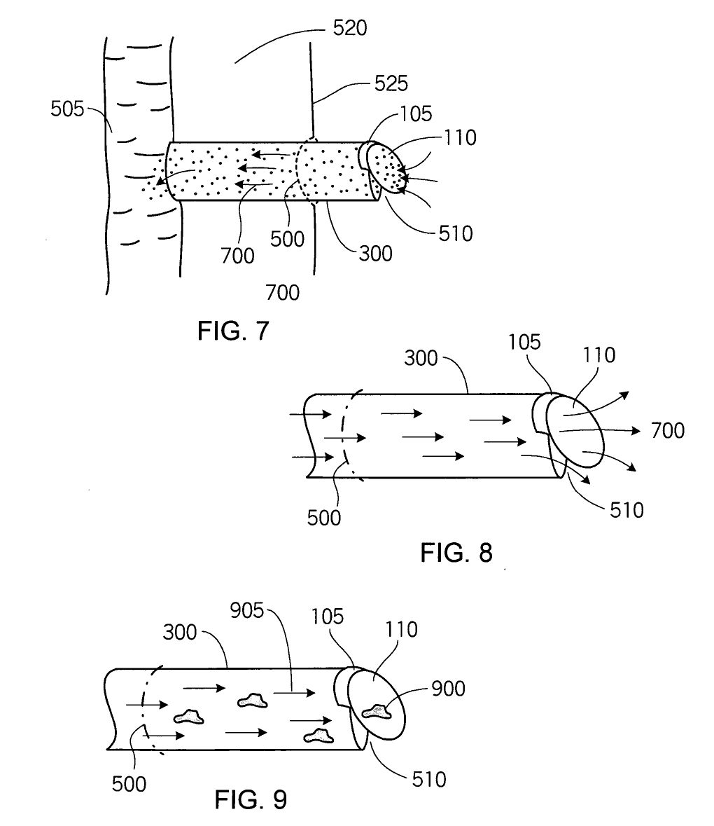

FIG. 7 depicts a side view of an exemplary tracheostomy nebulizing pad according to an embodiment of the present invention attached to a tracheostomy tube as water vapor from the exemplary tracheostomy nebulizing pad is mixed with inhaled air and taken through the tracheostomy tube passageway to reach and moisturize the orifice. When the flap 105 is securely adhered to the tracheostomy tube 300, the absorbent central core 110 is preferably in close proximity to, but not connected with, the passageway opening 510 of the tracheostomy tube 300. The absorbent central core 110, when saturated with a nebulizing agent such as water, may enable the user to inhale 700 moist air through the absorbent central core. As the user inhales air 700 through the tracheostomy tube 300, the nebulizing agent in the absorbent central core 110 is drawn from the absorbent central core into the tracheostomy tube 300 in vaporous form. As a result, the absorbent central core 110 may be used to nebulize the trachea 505 each time the user inhales through the tracheostomy tube 300. As such, this method of using the absorbent central core 110 may provide persistent trachea and stoma nebulizing.

FIG. 8 depicts a side view of an exemplary tracheostomy nebulizing pad according to an embodiment of the present invention attached to a tracheostomy tube as exhaled air passes unimpeded out through the tracheostomy tube passageway. As the user exhales through the tracheostomy tube 300, the space between the tracheostomy tube and the draped absorbent central core 110 may allow exhaled air 800 to be expelled without impediment.

FIG. 9 illustrates a side view of an exemplary tracheostomy nebulizing pad according to an embodiment of the present invention attached to a tracheostomy tube as secretions are expelled from the orifice through the tracheostomy tube passageway. Various secretions 900, such as irradiated tissue, mucus, blood, and bile may be expelled through a tracheostomy tube 300 with the intense force, such as the force produced when a user coughs. Without a nebulizing pad 100, these secretions 900 may be expelled from the tracheostomy tube 300 and onto objects in front of the user. In such a case, the nebulizing pad 100 may act as an absorbing wall. As secretions 900 are hurled through the tracheostomy tube 300 and out the passageway opening, the secretions 900 may contact the absorbent central core 110 instead of being freely emitted into the air.

In operation, the nebulizing pad 100 may be easily utilized by the user, caregiver, and/or health care provider in a manner that results in greater comfort and increased medical benefit for the user. Utilizing the nebulizing pad 100 may reduce the number of other time-consuming nebulizing procedures, which restrict the movement of the user during nebulization, needed by the user each day.

1. A nebulizing pad, comprising:
a flap; and
an absorbent central core attached to the flap,
wherein the flap includes an adhesive coating.

2. The nebulizing pad of claim 1 wherein the adhesive coating is pressure-sensitive.

3. The nebulizing pad of claim 1 wherein the adhesive coating includes one or more adhesive strips.

4. The nebulizing pad of claim 1 wherein the flap is shaped as an arched rectangle.

5. The nebulizing pad of claim 1 wherein the flap is flexible.

6. The nebulizing pad of claim 1 wherein the absorbent central core is made of one or more materials from the group consisting of fabrics, natural fibers, synthetic fibers and cellulose derivatives.

7. The nebulizing pad of claim 1 wherein the absorbent central core includes one or more portions that are pervious to liquids.

8. A method of nebulizing a tracheostomy tube of a user using a nebulizing pad having a flap and an absorbent central core attached to the flap, the method comprising:
adhering the flap of the nebulizing pad to an edge of the tracheostomy tube so that the absorbent central core of the nebulizing pad is positioned in front of an opening of the tracheostomy tube, wherein the flap includes an adhesive coating;
placing a nebulizing agent on the absorbent central core; and
using the nebulizing agent to nebulize the tracheostomy tube.

9. The method of claim 8 wherein the flap of the nebulizing pad is adhered to the top exterior edge of the tracheostomy tube.

10. The method of claim 8 wherein the adhesive coating of the flap is pressure-sensitive.

11. The method of claim 8 wherein the adhesive coating of the flap includes one or more adhesive strips.

12. The method of claim 8 wherein the nebulizing agent is water.

13. The method of claim 8 wherein the absorbent central core is proximate to the opening of the tracheostomy tube.

14. The method of claim 8 wherein placing the nebulizing agent comprises saturating the absorbent central core with the nebulizing agent.

15. The method of claim 8 wherein using the nebulizing agent comprises:
inhaling, by the user, through the tracheostomy tube; and
in response to the inhaling, nebulizing the tracheostomy tube with at least a portion of the nebulizing agent.
